(19) United States
(12) Patent Application Publication
(10) Pub. No.: US 2024/0104393 A1
(43) Pub. Date: Mar. 28, 2024

(54) PERSONALIZED FEDERATED LEARNING UNDER A MIXTURE OF JOINT DISTRIBUTIONS

(71) Applicant: NEC Laboratories America, Inc., Princeton, NJ (US)

(72) Inventors: Wei Cheng, Princeton Junction, NJ (US); Wenchao Yu, Plainsboro, NJ (US); Haifeng Chen, West Windsor, NJ (US); Yue Wu, Los Angeles, CA (US)

(21) Appl. No.: 18/466,333

(22) Filed: Sep. 13, 2023

Related U.S. Application Data
(60) Provisional application No. 63/407,530, filed on Sep. 16, 2022.
(60) Provisional application No. 63/408,553, filed on Sep. 21, 2022.

(51) Int. Cl. G06N 3/098

(52) U.S. Cl. CPC G06N 3/098

(57) ABSTRACT

Systems and methods for personalized federated learning. The method may include receiving at a central server local models from a plurality of clients, and aggregating a heterogeneous data distribution extracted from the local models. The method can further include processing the data distribution as a linear mixture of joint distributions to provide a global learning model, and transmitting the global learning model to the clients. The global learning model is used to update the local model.

### RELATED APPLICATION INFORMATION

This application claims priority to U.S. 63/407,530 filed on Sep. 16, 2022, incorporated herein by reference in its entirety.

This application claims priority to U.S. 63/408,553 filed on Sep. 21, 2022, incorporated herein by reference in its entirety.

### BACKGROUND

### Technical Field

The present invention relates to machine learning and more particularly to federated learning.

### Description of the Related Art

When moving to the high level human needs, the information that is used in machine learning is getting more personal. For example, banking information is personal. The detailed home address and social security number (SSN) of an individual are also personal information. Private chats in social networks can be personal. The security of this information can be critical to the safety and esteem of individuals.

As more attention is being put on the high-level needs using artificial intelligence and machine learning, among the most prominent concerns people have about modern technologies that access consumer/client data are those regarding privacy. It is common to assume that privacy is all about being able to control information about oneself, generally in the form of having a right to prevent others from obtaining or using information about a person without that person's consent. People have more and more interests in controlling information about themselves or preventing others from knowing things about themselves without their consent. Protection of such “security interests” constitutes an important reason people have for wanting to avoid having others acquire information about them.

Another factor to consider is the personalization. As we all know, premium services, such as those employing artificial intelligence and machine learning, are usually personalized and customized. In today's market, customer service is a huge differentiator. In order to earn loyalty, business needs to deliver personalized customer service. This means more than merely satisfying their low-level basic needs. Delivering truly personalized customer service is quite a feat. It entails making the customer feel like they are dealing with a company which treats them humanely. Protection of private data is the upmost concern for some consumers utilizing high level services, such as machine learning.

### SUMMARY

According to an aspect of the present invention, a computer implemented method is provided for personalized federated learning. In one embodiment, the method can include receiving at a central server local models from a plurality of clients; and aggregating a heterogeneous data distribution extracted from the local models. In one embodiment, the method can further include processing the data distribution as a linear mixture of joint distributions to provide a global learning model; and transmitting the global learning model to the clients, wherein the global learning model is used to update the local model.

In accordance with another embodiment of the present disclosure, a system for personalized federated learning is described that includes a hardware processor; and memory that stores a computer program product The computer program product when executed by the hardware processor, causes the hardware processor to receive, using the hardware processor, at a central server local models from a plurality of clients; and aggregate, using the hardware processor, a heterogeneous data distribution extracted from the local models. The computer program product can also process, using the hardware processor, the data distribution as a linear mixture of joint distributions to provide a global learning model; and transmit, using the hardware processor, the global learning model to the clients, wherein the global learning model is used to update the local model.

In accordance with yet another embodiment of the present disclosure a computer program product for personalized federated learning. The computer program product can include a computer readable storage medium having computer readable program code embodied therewith. The program instructions executable by a processor to cause the processor to receive, using the hardware processor, at a central server local models from a plurality of clients; and aggregate, using the hardware processor, a heterogeneous data distribution extracted from the local models. In some embodiments, the program instructions can also include to process, using the hardware processor, the data distribution as a linear mixture of joint distributions to provide a global learning model; and transmit, using the hardware processor, the global learning model to the clients, wherein the global learning model is used to update the local model.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a illustration of a general environment depicting federated learning, in accordance with one embodiment of the present disclosure.

FIG. 2 is a block/flow diagram of an exemplary method that uses a Federated Gaussian Mixture Model (Fed-GMM) to model the joint probability of samples in each client.

FIG. 3 is a block/flow diagram of an exemplary method for local training of the edge devices using local data, in accordance with embodiments of the present invention.

FIG. 4 is a block/flow diagram of an exemplary method for sending parameters to a central server in the federated learning environment, in accordance with embodiments of the present invention.

FIG. 5 is a block/flow diagram of an exemplary method aggravating parameters from a Gaussian mixture model, in accordance with embodiments of the present invention.

FIG. 6 is a block/flow diagram of an exemplary processing system for personalized federated learning, in accordance with embodiments of the present invention.

### DETAILED DESCRIPTION OF PREFERRED EMBODIMENTS

In accordance with embodiments of the present invention, systems and methods are provided for personalized federated learning. Personalized customer experiences employing machine learning and artificial intelligence may leverage customer data, thus privacy concerns arise.

Enterprises have been using model-centric machine learning (ML) approaches. In this example, a central machine learning (ML) model can be employed, which is present in the central server, and is trained with all available training data. With the recent data-centric artificial intelligence (AI) trend, the focus of artificial intelligence (AI) is shifting from model-centric to data-centric approaches. Data-centric artificial intelligence (AI) focuses on systematically improving the available data, which yields faster model building, shorter time for deployment, and improved accuracy. However, this approach brings its own set of challenges regarding the accessibility of the data. One problem is getting access to those huge amounts of data without causing data breaches to the companies or to individuals.

In response to rising concerns about data privacy, federated learning has been instituted, which allows training models collaboratively without sharing raw local data. This method brings the model to the local data rather than gathering the data in one place for the model training.

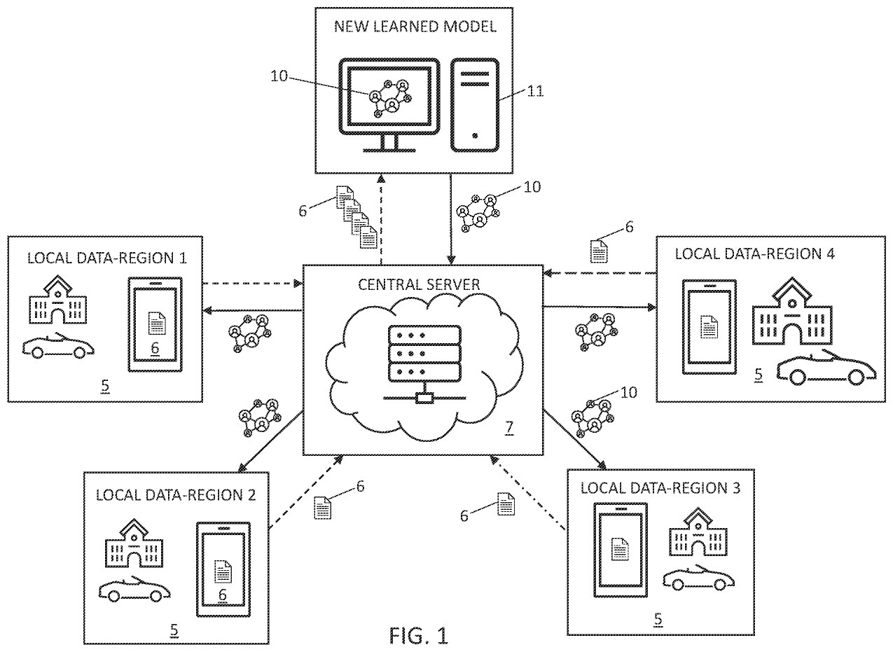

Referring to FIG. 1, the principle of federated learning is very simple. All clients 5 that have data on their devices, such as smartphones. A smartphone is only one example of a data containing device that may be used by the clients 5, as the data for the clients 5 may also be generated by sensor data from cars, branches of bank, and hospitals. The data is used at the individual clients 5 to train their individual models 6 (also referred to as local models 6). The individual model is identified by reference number 6. The clients 5 then send the model 6, not the data, to a central server 7 that combines the models for each of the individual classes and sends out the new combined model 8 to every client for further updating rounds. The central server 7 can aggregate the data. The aggregated data may then be used by a model generator 9 to create a new global model 10.

As noted, privacy interests have to be considered. To address the issue, the model generator 9 performs personalized federated learning (PFL), which collaboratively trains a federated model, i.e., generates a new global model 10, while considering local clients 5 under privacy constraints. It has been observed that existing PFL approaches result in suboptimal solutions when the joint distribution among local clients 5 diverges. The clients 5 can be highly different. For example, they can have different input distribution; they can have different conditional distribution; and the number of samples can be different.

In one example, a car sales prediction is considered, in which there are several dealers, e.g., sever auto sales dealers around the world, who want to use machine learning to predict how likely a car will be sold, as illustrated in FIG. 1. In some embodiments, the prediction model can take into account the car's specs and price as input and predict how likely the customer will buy it. In some embodiments, the model, make, color and price distributions of cars in the market are different in each regions (e.g., local data region 1 vs. local data region 2), which means the input distribution will be different. Second, even if the car and its price are the same, depending on the culture and economy, people from different regions can still have different preferences. This means the conditional distribution is also different, e.g., an example of being heterogeneous. A personalized algorithm added to the model is expected to both utilize the data globally and adapt to different markets. These heterogeneities indeed post obstacles for existing methods. Either they make some unrealistic assumptions, or propose very specific methods that are not generalizable to new tasks. It is noted that in this example, the prediction model is an example of a local model 6, as depicted in FIG. 1. The aforementioned make, model, price, color and local regions are all examples of parameters of the local model. These parameters can be extracted from the local model without divulging private information of the clients 5.

The methods, systems and computer program products that are described herein provide personalized federated learning under a mixture of joint distributions. In machine learning, a “distribution” is simply a collection of data, or scores, on a variable. In some embodiments, these scores are arranged in order from smallest to larges. Distribution can refer to how the data is spread out or clustered around certain values or ranges. By examining the distribution, insights can be gained into the characteristics and patterns of the data, which can be useful in making informed decisions and predictions

In machine learning, joint distributions refer to the probability distribution of two or more variables occurring together. These variables could be any features or attributes that are related to a particular problem.

In some embodiments, the goal of the methods, systems and computer program products that are described herein for personalized federated learning is to model the joint probability as a whole, and address the heterogeneity issue in a formal, rigorous way. Heterogeneity means that there is variability in the data. The opposite of heterogeneity is homogeneity meaning that all studies show the same effect.

Federated learning (FL) is a framework that allows edge device to collaboratively train a global model while keeping customers' data on-device. A standard FL system involves a cloud server 7 and multiple clients (devices). Each device has its local data and a local copy of the machine learning (ML) model 6 being served.

In each round of federated learning (FL) training, a cloud server 7 sends the current global model 10 to the clients 5, and the clients train 5 their local models 6 using on-device data and send the models 6 to a centralized server 7 (which may be cloud based 4). The server 7 aggregates the local models 6 and updates the global model 10. In some embodiments, the Federated learning (FL) also has a personalization branch, which aims to customize local models to improve their performance on local data.

Traditional federated learning (FL) assumes that clients are homogenous. However, in reality the data distribution [symbol] (x, y) of clients can be heterogenous. A personalized federated learning (FL) algorithm aims to utilize data from all clients 6, and generate model, e.g., global models 10, suitable for different clients.

In some embodiments, a Federated Gaussian Mixture Model (Fed-GMM) is proposed to jointly model the joint probability of samples in each client 5. This approach can use the linear mixture of several base distributions, while the weights π_{c} is personalized for each client. Given the model of the likelihood, we use log-likelihood maximization as the training criterion. The proposed model can automatically detect if the new clients data are from the same joint distribution of the data in existing clients. Thus, it is able to detect outlier of clients.

In one example, the data distribution [symbol] (x) is data includes colors, makes, models and pricing in the market for vehicle sales. The global learned model may provide based upon a given price, etc., a consumer's willingness to buy. This is only one example of what can be modeled by the global learned model, which can result from the aggregated data from local models from the clients in a federated learning scenario. As noted prior to the methods of the present disclosure, assume that the data is homogenous, and fail to address client heterogenerity. In some examples, the objective of the present disclosure addresses joint distribution heterogeneity in federated learning models.

In one embodiment, the methods, systems and computer program products of the present disclosure can model [symbol] (x, y) as a linear mixture of joint distributions. In one embodiment, the formulation:

[symbol]

_{c}(x,y)=Σᵢ₌₁^{M}π_{c}ⁱ [symbol] ⁱ(x,y), [symbol] ⁱ(x,y) Equation (1):

Can be applied to deep networks, in which the optimization goal, which is a log likelihood maximation, can be provided by:

$$∀ c ∈ C , \begin{matrix}max \\ {π}_{c} , θ\end{matrix} \begin{matrix}𝔼 \\ ( x , y ) ∼ {ℙ}_{c}\end{matrix} [ log ( {ℙ}_{{π}_{2} , θ} ( x , y ) ] \qquad Equation ( 2 )$$

In accordance with Equation (2), for a fixed client c, the methods, systems and computer program products of the present disclosure consider a fixed client c, which has a defined latent variable that is equal to:

z˜π_{c}(⋅),then (x,y)˜ [symbol] (⋅|z)= [symbol] _{θ}_{^{z}}(⋅) Equation (3):

in which the definition in Equation (3), implies:

[symbol]

_{π}_{_{c}}_{,θ}(x,y)=Σ_{i∈|M|}π_{c}ⁱ [symbol] _{θ}_{ⁱ}(x,y) Equation (4):

The approach for the federated learning model ( [symbol] (x, y)) that employs a linear mixture of joint distributions with Equations (1), (2), (3) and (4), can advantageously provide a highly expressive model, in which an increase in M provides for higher expressive power. The federated learning model ( [symbol] (x, y)) that employs a linear mixture of joint distributions with Equations (1), (2), (3) and (4), can advantageously be used to better guide supervised learning. Even further, the federated learning model ( [symbol] (x, y)) that employs a linear mixture of joint distributions with Equations (1), (2), (3) and (4), can advantageously be used for out of distribution detections. The equations described above with reference to equations (1)-(4), provides a simple yet powerful formulation for a personalized federated learning (FL) task.

The federated learning algorithm described above with reference to FIGS. 1-4 provides better expressivity and better supervised learning guidance. For example, existing federated learning models prior to the methods and systems of the present disclosure assumed a homogenous data distribution, i.e., assumed [symbol] (x) to be the same. One example of a prior learning model is as follows:

[symbol]

(y|x)=π₁ [symbol] ₁(y|x)+π₂ [symbol] ₂(y|x) Equation (5):

Equation (5) assumes that [symbol] (x) to be the same. The resulting classifier suffers from constant errors due to the assumption that [symbol] (x) is the same. The model provided by the methods, systems of the computer program products of the present disclosure does not assume homogenous data distributions. Contrary to the modeling provided by Equation (5), a federated learning model as a mixture of joint distributions to address data distributions [symbol] (x, y) that are heterogeneous is provided by Equation (6):

$$ℙ ( y \vert x ) = \frac{{π}_{1} {ℙ}_{1} ( x ) {ℙ}_{1} ( y \vert x ) + {π}_{2} {ℙ}_{2} ( x ) {ℙ}_{2} ( y \vert x )}{{π}_{1} {ℙ}_{1} ( x ) + {π}_{2} {ℙ}_{2} ( x )} \qquad Equation ( 6 )$$

The federated learning model provided by equation (6) can express a Bayesian optimal classifier.

The model provided by equation 6 is a federated gaussian mixture model (GMM), which can be used to estimate the probability ( [symbol] _{c}(x)) that a client (c) will act based upon the data (x). The base model is a Gaussian distribution [symbol] ⁱ(x, y)= [symbol] (x; μᵢ, Σi) [symbol] _{θ}i(y|x). The [symbol] _{θ}i(y|x) can be a deep supervised model parameterized by θⁱ. Algorithm derivation for the federated gaussian mixture model may include the following.

The general model may employ [N] to denote the set {1, 2, . . . , N}, e.g., set of data. Suppose there exist C clients, e.g., the illustration in FIG. 1 illustrates four (4) clients 10. In some embodiments, each client c∈[C] has its own dataset of size N_{c}, where a data s_{c,i}=(x_{c,i}, y_{c,i}) is assumed to be drawn from distribution [symbol] _{c}(x, y).

The model [symbol] (x, y) of the computer implemented methods, systems computer program products of the present disclosure employs a linear mixture of joint distribution

The multi-task federated learning tasks require a model P_{c}(x, y) (identified by reference number 6 in FIG. 1) for each client 10, such that they can achieve expected maximum log likelihood: ∀c∈ [symbol] ,

$${max}_{{π}_{c} , θ} {𝔼}_{( x , y ) ∼ {ℙ}_{c}} [ log ( {P}_{c} ( x , y ) ) ] .$$

In some embodiments, linear mixtures can be employed to model the probability. For the input distribution P_{c}(x), Gaussian mixture models (GMM) are employed. For the conditional distribution P_{c}(y|x), parameterized supervised learning models are employed.

The model is defined as follows:

All clients share the GMM parameters {μₘ_{₁}, Σₘ_{₁}} for m₁∈[M₁].

All clients share the supervised learning parameters θₘ_{₂} for m₂∈[M₂].

Each client c keeps its own personalized learner weights π_{c}(m₁, m₂), which satisfies Σₘ_{₁}_{,m}_{₂}π_{c}(m₁, m₂)=1.

Under the definition of the model, the optimization target will be equation 7 (M₁ or M₂ can be omitted when clear), as follows:

$$∀ c ∈ 𝒞 , \qquad Equation ( 7 )$$

$${max}_{{π}_{c} , θ} {𝔼}_{( x , y ) ∼ {ℙ}_{c}} [ log ( {\sum }_{{m}_{1} , {m}_{2}} {π}_{c} ( {m}_{1} , {m}_{2} ) 𝒩 ( x ; {μ}_{{m}_{1}} , {\sum }_{{m}_{1}} ) {P}_{{θ}_{{m}_{2}}} ( y \vert x ) ) ]$$

In a following step, the EM (Expectation-Maximization) algorithm is derived. The EM (Expectation-Maximization) algorithm is used in machine learning to obtain maximum likelihood estimates of variables.

To reduce notation clutter, m=(m₁, m₂) and Θₘ={μₘ_{₁}, Σₘ_{₁}, θₘ_{₂}}. The model is then denoted as P_{π}_{_{c}}_{,Θ}(x, Y)=Σₘπ_{c}(m)P_{Θ}_{ₘ}(x, y). Under this simplified notation, the EM algorithm is derived as follows:

First, qₛ(⋅) is a probability distribution over [M], where s=(x, y). Also, for each sample, a first sample is drawn by the latent random variable z˜π_{c}(⋅) and then sampling (x, y)˜P_{Θ}_{_{z}}(x, y). The EM algorithm is derived as follows:

$$\begin{matrix}{\sum }_{x , y} log ( {P}_{{π}_{c} , Θ} ( x , y ) ) & \geq & {\sum }_{x , y} {\sum }_{m ∈ [ M ]} {q}_{s} ( m ) & \\ & & log ( \frac{{P}_{{π}_{c} , Θ} ( z = m , x , y )}{{q}_{s} ( m )} ) & \\ & = & {\sum }_{x , y} {\sum }_{m ∈ [ M ]} {q}_{s} ( m ) [ log ( \frac{{P}_{{π}_{c} , Θ} ( z = m )}{{q}_{s} ( m )} ) + & \\ & & log ( {P}_{{π}_{c} , Θ} ( x , y \vert z = m ) ) ] & \\ & = & {\sum }_{x , y} {\sum }_{m ∈ [ M ]} {q}_{s} & Equation ( 8 ) \\ & & ( m ) [ log ( \frac{{π}_{c} ( m )}{{q}_{s} ( m )} ) + log ( {P}_{{Θ}_{m}} ( x , y ) ) ] & \\ & = & {\sum }_{x , y} {\sum }_{m ∈ [ M ]} {q}_{s} & Equation ( 9 ) \\ & & ( m ) [ log ( \frac{{P}_{{π}_{c} , Θ} ( z = m \vert x , y )}{{q}_{s} ( m )} ) + & \\ & & log ( {ℙ}_{{π}_{c} , Θ} ( x , y ) ) ] . & \end{matrix}$$

This evidence lower bound guides the EM algorithm:

For the expectation step (E-Step): Fix π_{c} and Θ, maximize Equation (9) via qₛ(m), and the optimal solution is equal to:

qₛ(m)=P_{π}_{_{c}}_{,Θ}(z=m|x,y)

∝ [symbol] _{π}_{_{c}}_{,Θ}(z=m,x,y)=π_{c}(m) [symbol] _{Θ}_{ₘ}(x,y).

For the maximation step (M-Step): Fix q(⋅|x, y), maximize Equation (8) via π_{c} and Θ, and the optimal solution will be:

$${π}_{c} ( m ) = \frac{1}{N} {\sum }_{x , y} {q}_{s} ( m ) ,$$

$${Θ}_{m} = arg {max}_{Θ} {\sum }_{x , y} {q}_{s} ( m ) log ( {ℙ}_{Θ} ( x , y ) ) .$$

Substitutions are then made for m=(m₁, m₂) and Θₘ={μₘ_{₁}, Σₘ_{₁}, θₘ_{₂}}. Further, indexing is performed for the base component [symbol] ₘ_{₁}_{,m}_{₂}(x, y)= [symbol] (x; μₘ_{₁}, Σₘ_{₁})⋅

$${ℙ}_{{θ}_{{m}_{2}}} ( y \vert x ) ,$$

where [symbol] is a Gaussian distribution, and

$${ℙ}_{{θ}_{{m}_{2}}} ( y \vert x )$$

is represented by some neural networks which outputs a distribution over the labels.

Under the aforementioned specific model, the updated rule can be rewritten as follows as:

For the expectation step (E-Step), the updated rules are rewritten as follows:

$${q}_{s} ( {m}_{1} , {m}_{2} ) = {π}_{c} ( {m}_{1} , {m}_{2} ) 𝒩 ( x ; {μ}_{{m}_{1}} , {\sum }_{{m}_{1}} ) \cdot {ℙ}_{{θ}_{{m}_{2}}} ( y \vert x ) .$$

For the maximation step (M-Step), the updated rule can be rewritten as:

$$\begin{matrix}{π}_{c} ( {m}_{1} , {m}_{2} ) = \frac{1}{{N}_{c}} {\sum }_{x , y} {q}_{s} ( {m}_{1} , {m}_{2} ) , \\ μ , \text{} \sum , \text{} θ = arg {max}_{μ , \sum , θ} {\sum }_{x , y} {q}_{s} ( {m}_{1} , {m}_{2} ) log ( {ℙ}_{μ , \sum } ( x ) ) + \\ {\sum }_{x , y} {q}_{s} ( {m}_{1} , {m}_{2} ) log ( {ℙ}_{θ} ( y \vert x ) ) .\end{matrix}$$

Further calculation will show it is equivalent to:

$$\begin{matrix}{π}_{c} ( {m}_{1} , {m}_{2} ) = \frac{1}{{N}_{c}} {\sum }_{x , y} {q}_{s} ( {m}_{1} , {m}_{2} ) , \\ {μ}_{{m}_{1}} = \frac{{\sum }_{x , y} {\sum }_{{m}_{2}} {q}_{s} ( {m}_{1} , {m}_{2} ) x}{{\sum }_{x , y} {\sum }_{{m}_{2}} {q}_{s} ( {m}_{1} , {m}_{2} )} , \\ {\sum }_{{m}_{1}} = \frac{{\sum }_{x , y} {\sum }_{{m}_{2}} {q}_{s} ( {m}_{1} , {m}_{2} ) ( x - {μ}^{Z} ) {( x - {μ}^{Z} )}^{T}}{{\sum }_{x , y} {\sum }_{{m}_{2}} {q}_{s} ( {m}_{1} , {m}_{2} )} \\ {θ}_{{m}_{2}} = arg {max}_{θ} {\sum }_{x , y} {\sum }_{{m}_{1}} {q}_{s} ( {m}_{1} , {m}_{2} ) log ( {ℙ}_{θ} ( y \vert x ) ) .\end{matrix}$$

The complete algorithm derivation for Federated Learning with a Gaussian Mixture Model is as follows:

Algorith for Federated Learning with GMM

| | |
|---|---|
| 1: | for t = 1,2, . . . do |
| 2: | server broadcasts {μₘ^{(t-1)}, Σₘ^{(t-1)}, θₘ^{(t-1)}} to all clients |
| 3: | for client c ∈ [C] do |
| 4: | for component m₁ ∈ [M₁], m₂ ∈ [M₂] do |
| 5: | for sample s_{c,i} = (x_{c,i}, y_{c,i}), i ∈ [N_{c}] do |
| 6: | Set qₛ_{_{c,i}}^{(t)}(m₁, m₂) ∝ π_{c}^{(t-1)}(m₁, m₂) · [symbol] (x_{c,i}; μₘ_{₁}^{(t-1)}, |
| | Σₘ_{₁}^{(t-1)}) · exp (−L_{CE}(s_{c,i}; θₘ_{₂}^{(t-1)})) |
| 7: | end for |
| 8: | Set for all m₁ ∈ [M₁], m₂ ∈ [M₂] : |

```
  ${π}_{c}^{( t )} ( {m}_{1} , {m}_{2} ) = \frac{1}{{N}_{c}} {\sum }_{i ∈ [ {N}_{c} ]} {q}_{{s}_{c , i}}^{( t )} ( {m}_{1} , {m}_{2} )$
  ${μ}_{{m}_{1} , c}^{( t )} = \frac{{\sum }_{i ∈ [ {N}_{c} ]} {\sum }_{{m}_{2} ∈ [ {M}_{2} ]} {q}_{{s}_{c , i}}^{( t )} ( {m}_{1} , {m}_{2} ) {x}_{c , i}}{{\sum }_{i ∈ [ {N}_{c} ]} {\sum }_{{m}_{2} ∈ [ {M}_{2} ]} {q}_{{s}_{c , i}}^{( t )} ( {m}_{1} , {m}_{2} )}$
  ${\sum }_{{m}_{1} , c}^{( t )} = \frac{{\sum }_{i ∈ [ {N}_{c} ]} {\sum }_{{m}_{2} ∈ [ {M}_{2} ]} {q}_{{s}_{c , i}}^{( t )} ( {m}_{1} , {m}_{2} ) ( {x}_{c , i} - {μ}_{m , c}^{( t )} ) {( {x}_{c , i} - {μ}_{m , c}^{( t )} )}^{⊤}}{{\sum }_{i ∈ [ {N}_{c} ]} {\sum }_{{m}_{2} ∈ [ {M}_{2} ]} {q}_{{s}_{c , i}}^{( t )} ( {m}_{1} , {m}_{2} )}$
  ${θ}_{{m}_{2} , c}^{( t )} = arg {min}_{θ} {\sum }_{i ∈ [ {N}_{c} ]} {\sum }_{{m}_{1} ∈ [ {M}_{1} ]} {q}_{{s}_{c , i}}^{( t )} ( {m}_{1} , {m}_{2} ) {L}_{CE} ( {x}_{c , i} , {y}_{c , i} ; θ )$
```

| | |
|---|---|
| 9: | end for |

| | |
|---|---|
| 10. | client c sends {μₘ_{₁}^{(t)}, c, Σₘ_{₁}^{(t)}, c θₘ_{₂}^{(t)}, c, |

γ_{c}^{(t)}(m₁, m₂) = Σ_{iϵ[N}_{_{c}}_{]} qₛ_{_{c,i}}^{(t)} (m₁, m₂)} to the server

| | |
|---|---|
| 11. | end for |
| 12. | for Gaussian component m₁ϵ[M₁]do |
| 13. | server aggregates |

```
    ${μ}_{{m}_{1}}^{( t )} = \frac{{\sum }_{c ∈ [ C ]} {\sum }_{{m}_{2} ∈ [ {M}_{2} ]} {γ}_{c}^{( t )} ( {m}_{1} , {m}_{2} ) {μ}_{{m}_{1} , c}^{( t )}}{{\sum }_{c ∈ [ C ]} {\sum }_{{m}_{2} ∈ [ {M}_{2} ]} {γ}_{c}^{( t )} ( {m}_{1} , {m}_{2} )}$
      ${\sum }_{{m}_{1}}^{( t )} = \frac{{\sum }_{c ∈ [ C ]} {\sum }_{{m}_{2} ∈ [ {M}_{2} ]} {γ}_{c}^{( t )} ( {m}_{1} , {m}_{2} ) {\sum }_{{m}_{1} , c}^{( t )}}{{\sum }_{c ∈ [ C ]} {\sum }_{{m}_{2} ∈ [ {M}_{2} ]} {γ}_{c}^{( t )} ( {m}_{1} , {m}_{2} )}$
```

| | |
|---|---|
| 14. | end for |
| 15. | for Supervised component m₂ϵ [M₂] do |
| 16. | Server aggregates |

${θ}_{{m}_{2}}^{( t )} = \frac{{\sum }_{c ∈ [ C ]} {\sum }_{{m}_{1} ∈ [ {M}_{1} ]} {γ}_{c}^{( t )} ( {m}_{1} , {m}_{2} ) {θ}_{{m}_{2} , c}^{( t )}}{{\sum }_{c ∈ [ C ]} {\sum }_{{m}_{1} ∈ [ {M}_{1} ]} {γ}_{c}^{( t )} ( {m}_{1} , {m}_{2} )}$

| | |
|---|---|
| 17. | end for |
| 18. | end for |

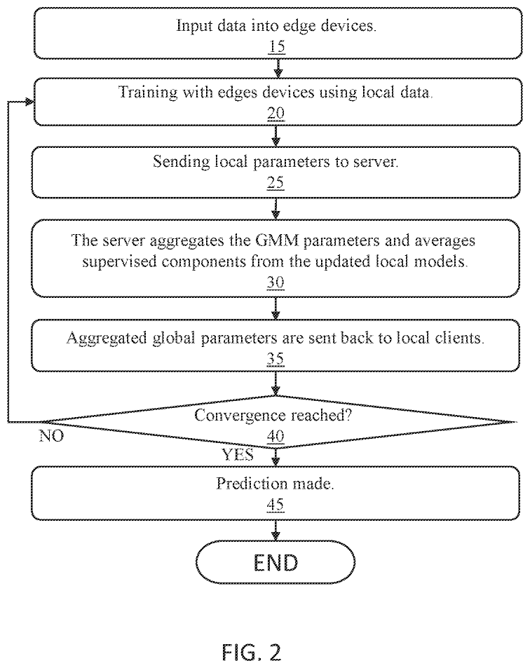

FIG. 2 is a flow chart illustrating one embodiment of a method that uses a Federated Gaussian Mixture Model (Fed-GMM) to jointly model the joint probability of samples in each client 5, as illustrated in FIG. 1. Each client will keep its own data locally, however the clients 5 will communicate to a centralized server 7, e.g., computing server, supervised predictive components parameters and GMM parameters.

The method may begin with block 15. Block 15 can include input data being loaded into the edge devices. An edge device is any piece of hardware that controls data flow at the boundary between two networks. Edge devices fulfill a variety of roles, depending on what type of device they are, but they essentially serve as network entry—or exit—points. In the embodiment depicted in FIG. 1, the edge device may be a mobile computer, or it may be devices that collect data, e.g., via a motor vehicle or a specific institution, e.g., a banking institution or hospital. The edge devices can collect data from different regions, which may be different geographic regions, such as local data region 1, local data region 2, local data region 3, and local data region 4, etc.

In the example, of preparing a model that will predict likelihood of a purchase by a customer, e.g., the purchase of a vehicle, the data being input into the edge devices could be specifications on the product being sold. For example, if the product is a vehicle, the type of vehicle, e.g., coupe, sedan, truck, may be one type of data, as well as the color, make, model and price of the vehicle. Other data can include the region in which the sale is being made, and preferences by customers specific to that region.

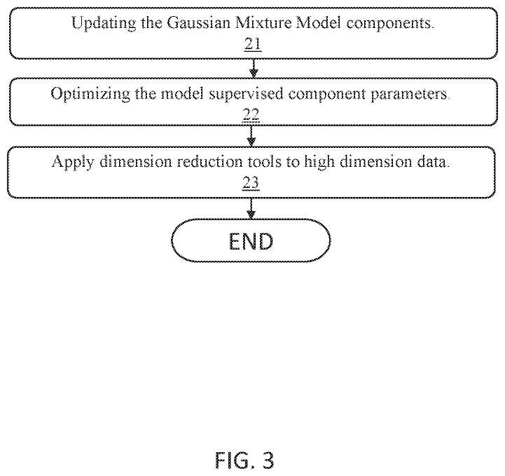

Referring to block 20, following the input data being entered into the edge devices, the edge devices can train the local model 6. Referring to FIG. 3, training the local model 6 can include updating the Gaussiaum Mixture Model components of the local model 6 at block 21. This is one mechanism by which heterogeneity in clients can be considered by the methods of the present disclosure. Training the local mode 61 can also include optimizing the model supervised component parameters at block 22. Training the local model can also include applying dimension reduction tools to high dimension data at block 23. For example, if the data is high-dimensional, dimension reduction tools are applied such as an auto-encoder.

The methods of the present disclosure utilize data from all the clients 5. Further the predictive models provided by the present method are suitable for all the different clients, e.g., the clients 5 from local data-region 1, local data-region 2, local data-region 3 and local data region 4.

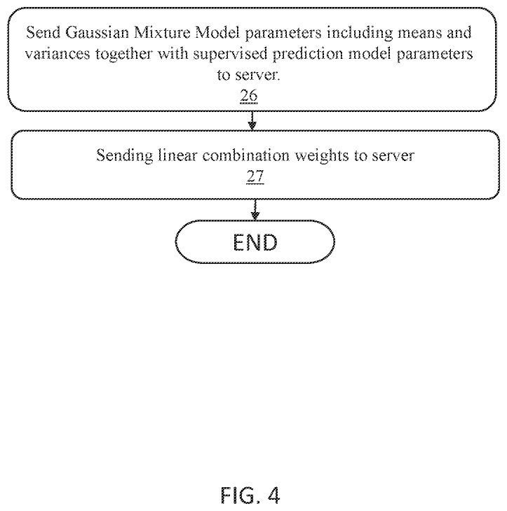

Referring back to FIG. 2, the method may continue at block 25, which includes sending the local model parameters 6 to the server. Referring to FIG. 1, each of the clients 5 is in communication with a central server 7. The centralized server 7 may be in communication to the clients wirelessly, and the centralized server 7 can be a cloud based system. Each client will keep its own data locally, however the clients will communicate to a centralized server, e.g., computing server, supervised predictive components parameters and GMM parameters. This provides a level of data security to the clients, as the data is not sent to the centralized server 7. Referring to FIG. 4, sending the local model parameters 6 to the server 7 may include sending the Gaussian Mixture Model parameter includes means variances together with supervised prediction mode parameters to the server 6. In a following step, the liner combination weights are also sent to the server 7.

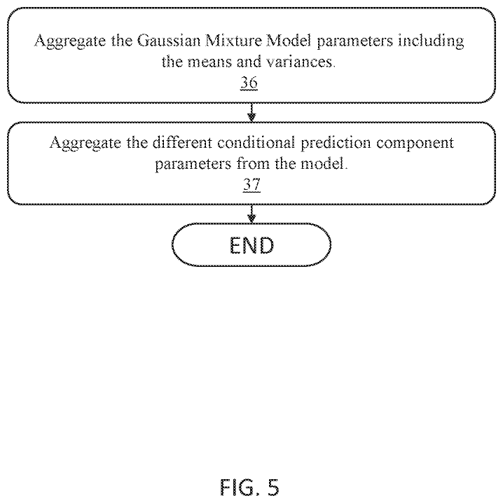

Referring back to FIG. 2, in a following step the method may continue to block 30. Block 30 includes the server 7 aggregating the Gaussian Mixture Model parameters and averages the supervised components from the updated local models. Referring to FIG. 5, aggregation at the server 7 may include aggregating the Gaussian Mixture Model parameters including the means and variances at block 36; and aggregating the different conditional prediction component parameters from the local models at block 37. Referring to block 1, the aggregated data is forwarded to a global model generator 11, at which new learned models are generated from the aggravated data. In one embodiment, aggregating the Gaussian Mixture Model parameters including the means and variances at block 36 can includes calculations in accordance with the algorithms from lines 12-14 of the complete algorithm derivation for Federated Learning with a Gaussian Mixture Model. In one embodiment, aggregating the different conditional prediction component parameters from the local models at block 37 can includes calculations in accordance with the algorithms from lines 15-17 of the complete algorithm derivation for Federated Learning with a Gaussian Mixture Model.

Referring back to FIG. 2, in a following process step, at block 35, the aggregated global parameters are sent back to the local clients 5. The updated models, i.e., updated global model, is transmitted from the global model generator 11 to the central server 7, and ultimately to the clients 5. The local client 5 can then use the new learned model from the global model generator to update both the Gaussian Mixture Model and the predictive components.

Referring back to FIG. 2, in a following step, a determination is made whether convergence has been reached at decision block 40. A machine learning model reaches convergence when it achieves a state during training in which loss settles to within an error range around the final value. In other words, a model converges when additional training will not improve the model. If convergence has not been reached at decision block 40, the method can loop back to block 20, and repeat the steps associated with blocks 20, 25, 30 and 35, wherein another check for convergence is performed at block 40 following block 35. The steps associated with blocks 20, 25, 30 and 35 are looped until convergence is reached.

In some embodiments, when convergence is reached at decision block 45, the edge (client) devices have been fully trained to make predictions, and data relevant to predictions at the local edge devices may be entered into the edge devices to make predictions using a local model updated using the updated global model created using blocks 20, 25, 30 and 35. The trained model can then make a prediction at block 45.

In some embodiments, when there comes a new client with its own data, the model can calculate the probability that the new client data obey the mixture of distribution of existing training data.

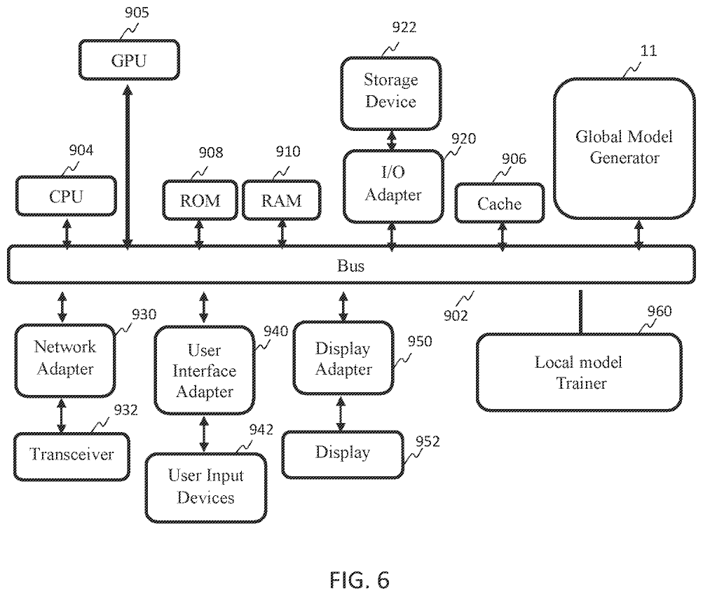

FIG. 6 is an exemplary processing system for personalized federated learning under a mixture of joint distribution, in accordance with embodiments of the present invention.

The processing system includes at least one processor (CPU) 904 operatively coupled to other components via a system bus 902. A GPU 905, a cache 906, a Read Only Memory (ROM) 908, a Random Access Memory (RAM) 910, an input/output (I/O) adapter 920, a network adapter 930, a user interface adapter 940, and a display adapter 950, are operatively coupled to the system bus 902. Additionally, element 900 is a local model trainer following FIGS. 1 and 2. The local model trainer 900 can perform the steps described in block 35 of FIG. 2. More particularly, the local trainer 900 employs the global model that is generated by the global model generator 11, as depicted in FIG. 1. The global model generator 11 generally receives aggravated data from the central server 7, and generated a new global model employing the steps described in blocks 25 and 30 of FIG. 2.

A storage device 922 is operatively coupled to system bus 902 by the I/O adapter 920. The storage device 922 can be any of a disk storage device (e.g., a magnetic or optical disk storage device), a solid-state magnetic device, and so forth.

A transceiver 932 is operatively coupled to system bus 902 by network adapter 930.

User input devices 942 are operatively coupled to system bus 902 by user interface adapter 940. The user input devices 942 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 942 can be the same type of user input device or different types of user input devices. The user input devices 942 are used to input and output information to and from the processing system.

A display device 952 is operatively coupled to system bus 902 by display adapter 950.

Of course, the processing system may also include other elements (not shown), as readily contemplated by one of skill in the art, as well as omit certain elements. For example, various other input devices and/or output devices can be included in the system, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system are readily contemplated by one of ordinary skill in the art given the teachings of the present invention provided herein.

As used herein, the terms “data,” “content,” “information” and similar terms can be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, the data can be received directly from the another computing device or can be received indirectly via one or more intermediary computing devices, such as, for example, one or more servers, relays, routers, network access points, base stations, and/or the like. Similarly, where a computing device is described herein to send data to another computing device, the data can be sent directly to the another computing device or can be sent indirectly via one or more intermediary computing devices, such as, for example, one or more servers, relays, routers, network access points, base stations, and/or the like.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “calculator,” “device,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can include, or store a program for use by or in connection with an instruction execution system, apparatus, or device.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer implemented method for personalized federated learning comprising:
receiving at a central server local models from a plurality of clients;
aggregating a heterogeneous data distribution extracted from the local models;
processing the data distribution as a linear mixture of joint distributions to provide a global learning model; and
transmitting the global learning model to the clients, wherein the global learning model is used to update the local model.

2. The computer implemented method of claim 1, wherein the receiving local models at the central server includes sending parameters from the local models.

3. The computer implemented method of claim 1, wherein the receiving local models at the central server does not include private data from the plurality of clients.

4. The computer implemented method of claim 1, wherein the local model updated by the global learning model is used to predict an outcome from input data applied to the local model updated by the global learning model.

5. The computer implemented method of claim 1, wherein an outcome predicted is used to perform a sale at a price and specification in accordance with input data that results in prediction of a successful sale.

6. The computer implemented method of claim 1, wherein training of the local models uses a log-likelihood maximization as training criterion.

7. The computer implemented method of claim 1, wherein the global learning model is a Federated Gaussian Mixture Model (Fed-GMM) that jointly models joint probability of samples in each client of the plurality of clients.

8. The computer implemented method of claim 7, wherein the Fed-GMM that provides the linear mixture of joint distributions, further includes weight for parameters of the model that is personalized for each client.

9. A system for personalized federated learning comprising:
a hardware processor; and
a memory that stores a computer program product, the computer program product when executed by the hardware processor, causes the hardware processor to:
receive, using the hardware processor, at a central server local models from a plurality of clients;
aggregate, using the hardware processor, a heterogeneous data distribution extracted from the local models;
process, using the hardware processor, the data distribution as a linear mixture of joint distributions to provide a global learning model; and
transmit, using the hardware processor, the global learning model to the clients, wherein the global learning model is used to update the local model.

10. The system of claim 9, wherein the receiving local models at the central server includes sending parameters from the local models.

11. The system of claim 9, wherein the receiving local models at the central server does not include private data from the plurality of clients.

12. The system of claim 9, wherein the local model updated by the global learning model is used to predict an outcome from input data applied to the local model updated by the global learning model.

13. The system of claim 9, wherein an outcome predicted is used to perform a sale at a price and specification in accordance with the input data that results in prediction of a successful sale.

14. The system of claim 9, wherein training of the local models uses a log-likelihood maximization as training criterion.

15. The system of claim 9, wherein the global learning model is a Federated Gaussian Mixture Model (Fed-GMM) that jointly models joint probability of samples in each client of the plurality of clients.

16. A computer program product for personalized federated learning, the computer program product can include a computer readable storage medium having computer readable program code embodied therewith, the program instructions executable by a hardware processor to cause the hardware processor to:
receive, using the hardware processor, at a central server local models from a plurality of clients;
aggregate, using the hardware processor, a heterogeneous data distribution extracted from the local models;
process, using the hardware processor, the data distribution as a linear mixture of joint distributions to provide a global learning model; and
transmit, using the hardware processor, the global learning model to the clients, wherein the global learning model is used to update the local model.

17. The computer program product of claim 16, wherein the receiving local models at the central server includes sending the parameters from the local models.

18. The computer program product of claim 16, wherein the receiving local models at the central server does not include private data from the plurality of clients.

19. The computer program product of claim 16, wherein the local model updated by the global learning model is used to predict an outcome from input data applied to the local model updated by the global learning model.

20. The computer program product of claim 16, wherein an outcome predicted is used to perform a sale at a price and specification in accordance with input data that results in prediction of a successful sale.
